(19) United States
(12) Patent Application Publication
(10) Pub. No.: US 2025/0145775 A1
(43) Pub. Date: May 8, 2025

(54) SYNTHESIS OF MELAMINE POLYPHOSPHATE WITH LOW RESIDUAL MELAMINE

(71) Applicant: BASF SE, Ludwigshafen Am Rhein (DE)

(72) Inventors: Jan Eberhardt, Lampertheim (DE); Pascal Guyon, Lampertheim (DE); Thomas Esche, Kaisten (DE)

(21) Appl. No.: 18/837,978

(22) PCT Filed: Feb. 9, 2023
(86) PCT No.: PCT/EP2023/053258

§ 371 Date: Aug. 13, 2024

(30) Foreign Application Priority Data
Feb. 18, 2022 (EP) 22157430.4

(51) Int. Cl. C08J 3/28; C08G 79/04

(52) U.S. Cl. CPC C08J 3/28; C08G 79/04

(57) ABSTRACT

The present invention relates to a method for producing a melamine depleted melamine polyphosphate which comprises heating a crude melamine polyphosphate for a hold time of at least one hour to a hold temperature of above 290° C.; to a melamine depleted melamine polyphosphate which contains a residual melamine and where the residual melamine concentration is below 0.2 wt %; and to a polymer composition comprising the melamine depleted melamine polyphosphate.

The present invention relates to a method for producing a melamine depleted melamine polyphosphate which comprises heating a crude melamine polyphosphate for a hold time of at least one hour to a hold temperature of above 290° C.; to a melamine depleted melamine polyphosphate which contains a residual melamine and where the residual melamine concentration is below 0.2 wt %; and to a polymer composition comprising the melamine depleted melamine polyphosphate. Combinations of preferred embodiments with other preferred embodiments are within the scope of the present invention.

Melamine polyphosphate is a commercially available halogen free flame retardant and often used in polyamide 66, 6, 11, 12, thermoplastic polyurethane and polyurethane. This flame retardant decomposes endothermically above 350° C., acting as a heat sink to cool the polymer. The released phosphoric acid further reacts with the polymer to form a char and inhibit the release of free radical gasses into the oxygen phase. Simultaneously, nitrogen species released from the degradation of melamine intumesces the char to further protect the polymer.

Melamine polyphosphate usually comprises trace amounts of melamine. Melamine is labelled as H361f “Suspected of damaging fertility” under the GHS System (Globally Harmonized System of Classification, Labelling and Packaging of Chemicals) of the United Nations.

Objects were to find a production method for melamine polyphosphate which results in a very low concentration of residual melamine.

The object was solved by a method for producing a melamine depleted melamine polyphosphate which comprises heating a crude melamine polyphosphate for a hold time of at least one hour to a hold temperature of above 290° C.

The object was also solved by a melamine depleted melamine polyphosphate which contains a residual melamine and where the residual melamine concentration is below 0.2 wt %. The object was also solved by a polymer composition comprising the melamine depleted melamine polyphosphate or obtainable by the method for producing the melamine depleted melamine polyphosphate which comprises heating a crude melamine polyphosphate for a hold time of at least one hour to a hold temperature of above 290° C.

A suitable overall reaction scheme can be as follows:

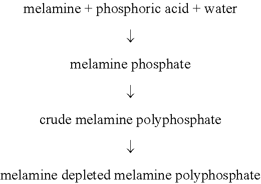

### Melamine Phosphate

The crude melamine polyphosphate can be produced by polymerizing melamine phosphate. The melamine phosphate is preferably obtainable from the reaction of melamine, phosphoric acid and water.

The phosphoric acid typically used in form of an aqueous solution of phosphoric acid, e.g. at a concentration of at least 50, 60 or 70 wt % or 70-90 wt %. The phosphoric acid has usually less than 1000, 100 or 10 ppm heavy metals (may be determined as Pb according to PLC08 method). The aqueous solution of phosphoric acid can be added to the melamine in single or multiple portions, or continuously, e.g. by spraying.

The melamine is typically used in solid form, such as a powder or granules. The melamine has usually a purity of at least 95, 98 or 99%, which may be determined by titration with HClO4. Melamine has the chemical structure as follows:

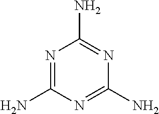

The water can be added to the reaction in form of the aqueous solution of the phosphoric acid, or in form of water, or both in form of the aqueous solution of the phosphoric acid and in form of water. The water can be added to the melamine in single or multiple portions, or continuously, e.g. by spraying.

The weight ratio of water added to melamine can be from 10:100 to 60:100, preferably from 20:100 to 50:100, and in particular from 30:100 to 45:100. For calculating the weight ratio of water to melamine the total amount of water is summed up from added aqueous solution of the phosphoric acid and water.

Typically, the melamine phosphate is prepared by heating melamine, phosphoric acid and water above a reaction temperature of 70, 75, 80, 85, 90, or 95° C. Typically, the melamine phosphate is prepared by heating melamine, phosphoric acid and water below a reaction temperature of 160, 150, 140, 130, 120, 110 or 100° C. Typically, the melamine phosphate is prepared by heating melamine, phosphoric acid and water at reaction temperature in the range of 70-130° C., 70-120° C., 75-110° C. The reaction temperature usually refers to the temperature of the reactants.

The melamine phosphate is prepared by heating melamine, phosphoric acid and water at least 0.5, 1, 3, 4, 5 or 6 hours, e.g. from 1 to 20 hours or from 2 to 12 hours. Water can be removed during the process by applying a reduced pressure, such as below 800, 500, or 400 mbar.

Preferably, the melamine phosphate is prepared by adding phosphoric acid and water to a powder of melamine.

More preferably, the melamine phosphate is prepared by adding an aqueous solution of phosphoric acid and water to a powder of melamine, where the weight ratio of water added to melamine can be from 10:100 to 60:100, preferably from 20:100 to 50:100, and in particular from 30:100 to 45:100.

The melamine phosphate is usually dried at elevated temperatures, in vacuum or at elevated temperatures in vacuum.

The melamine phosphate may contain the melamine and the phosphoric acid in a molar ratio of 1:1 to 2:1, 1.2:1 to 1.5:1, 1.25:1 to 1.4:1, or 1.25:1 to 1.35:1. In one form the melamine phosphate contains the melamine and the phosphoric acid in a molar ratio of 1.2:1 to 1.5:1. The molar ratio in the melamine phosphate can be adjusted by selecting appropriate molar amounts of the educts.

The melamine phosphate may have a purity of at least 80, 90 or 95%, which may be determined by HNMR.

The melamine phosphate may have a water content of below 5, 3, or 1 wt %, which may be determined by determined with a moisture analyzer comprising a weighing and a halogen heating unit.

### Crude Melamine Polyphosphate

The crude melamine polyphosphate is usually produced by polymerizing the melamine phosphate for a polymerization time of at least 0.5 hour at a polymerization temperature in the range of 200 to 290°.

The polymerization temperature can be at least 220, 240, 250, 260, 265 or 270° C. In one form the polymerization temperature is at least 250° C. In another form the polymerization temperature is at least 260° C. In another form the polymerization temperature is at least 265° C. The polymerization temperature can be up to 280, 285, or 290° C. The polymerization temperature can be in a range from 230 to 290° C., preferably from 260 to 290° C., and in particular from 280 to 290° C. The polymerization temperature usually refers to the temperature of the reactants.

The polymerization of the phosphate units to polyphosphate units is usually an endothermic reaction, which means that even during adding heat energy to the melamine phosphate the polymerization temperature remains constant.

The polymerization time is at least 0.5 hour, such as 1, 2, 3, 4 or 5 hours. In one form the polymerization time is at least two hours. In another form the polymerization time is at least three hours. In another form the polymerization time is at least three hours. In another form the polymerization time is at least four hours. The polymerization time can be up to 20 hours, such as up to 15 hours, or up to 10 hours. The polymerization time can be in a range from 1 to 20 hours, preferably from 2 to 15 hours, and in particular from 3 to 10 hours.

The polymerizing of the melamine phosphate is usually done while agitating the melamine phosphate, e.g. by stirring, or by injecting an inert gas. The inert gas may be air, nitrogen, or a noble gas, where nitrogen is preferred.

The polymerization of the phosphate units to polyphosphate units typically results in the formation of reaction water, which may be measured by an pressure increase.

The reaction water can be removed during the polymerization. The reaction water can be removed by purging with an inert gas or by applying a vacuum. In one form the reaction water is removed by purging with an inert gas.

The inert gas may be air, nitrogen, or a noble gas, where nitrogen is preferred. The purging can be done by a volume stream which results in an exchange of the volume above the polymerization at least 1, 2, 3, 4 or 5 times per hour.

In another form the reaction water is removed by applying a vacuum, such as at least 0.9 bar, 0.5 bar or 0.1 bar.

The melamine phosphate is usually polymerized in an atmosphere to which no ammonia is added. In another form the melamine phosphate is polymerized in an atmosphere which is depleted of ammonia. In another form the melamine phosphate is polymerized in an inert gas atmosphere.

Typically, a reaction mixture is polymerized which comprises at least 60, 70, 80, 90, 95, 96, 97, 98, 99 or 99.5 wt % of the melamine phosphate. The concentration of the melamine phosphate in the reaction mixture usually refers to the concentration before the polymerization has started. In one form a reaction mixture is polymerized which is free of other compounds, such as polymerization catalysts or reactants.

The reaction mixture may optionally comprise a polymerization catalyst, such as alkali metal hydroxides, alkaline earth metal hydroxides, or salts of boric acid (e.g. zinc borate). If a polymerization catalyst is used, the amount used will generally be between 0.1 wt % and 10 wt % of the reaction mixture. Preferably, the reaction mixture is free of a polymerization catalyst.

In one form the reaction mixture can be free of a water-releasing compound, such as borax, aluminum hydroxide, magnesium hydroxide, and mixtures thereof. In another form the reaction mixture may contain less than 5, 3, 2, 1, 0.5 or 0.1 wt % of the water-releasing compound

In one form the reaction mixture may be free of urea. In another form the reaction mixture may contain less than 5, 3, 2, 1, 0.5 or 0.1 wt % of urea. In another form the reaction mixture may contain less than 0.1, 0.05, or 0.01 mol urea per mol of phosphoric acid.

In one form the reaction mixture may be free of a metal oxide, metal hydroxide, metal oxohydroxide, metal (hydroxy)carbonates or layered double hydroxides (LDH) of Mg, Zn and Al, such as MgO, Mg(OH)2, Al₂O₃, Al(O)OH (Boehmit), ZnO, Zn(OH)2 und Mg, Al-, Zn, Al- and Mg/Zn, Al-hydrotalcit or hydromagnesit, MgCO3 or ZnCO3. In another form the reaction mixture may contain less than 5, 3, 2, 1, 0.5 or 0.1 wt % of the metal oxide, metal hydroxide, metal oxohydroxide, metal (hydroxy)carbonates or layered double hydroxides (LDH) of Mg, Zn and Al.

In one form the reaction mixture may be free of organic solvents. In another form the reaction mixture may contain less than 5, 3, 2, 1, 0.5 or 0.1 wt % of an organic solvent.

The polyphosphate in the crude melamine polyphosphate may have a degree of polymerization of at least 10, 20, 30 or 40, and may be determined by 31P solid NMR.

At the end of the polymerization time the resulting crude melamine polyphosphate can be used directly for producing the melamine depleted melamine polyphosphate, such as without further workup steps or without cooling down. Preferably, the crude melamine polyphosphate is used at the polymerization temperature for producing the melamine depleted melamine polyphosphate, e.g. by increasing the temperature from the polymerization temperature to the hold temperature.

In another form at the end of the polymerization time the resulting crude melamine polyphosphate can be cooled down, e.g. to below 150° C., 120° C. or 100° C. The cooling can be achieved by stirring without heating, or by injecting an inert gas which a lower temperature. After cooling down the crude melamine polyphosphate is usually obtained in solid form, e.g. as powder, and can be additionally grinded, milled, pressed, granulated or tableted.

The crude melamine polyphosphate has usually a residual melamine concentration of at least 0.1, 0.2, or 0.25 wt % melamine.

### Melamine Depleted Melamine Polyphosphate

The invention also relates to the melamine depleted melamine polyphosphate which contains a residual melamine and where the residual melamine concentration is below 0.2 wt %, 0.1 wt % or 0.05 wt %. The melamine depleted melamine polyphosphate is obtainable by the method comprising heating the crude melamine polyphosphate for a hold time of at least one hour to a hold temperature of above 290° C.

The invention also relates to the method for producing melamine depleted melamine polyphosphate comprises heating the crude melamine polyphosphate for a hold time of at least one hour to a hold temperature of above 290° C.

The hold temperature can be at least 295° C., 300° C., 305° C., 310° C., 315° C., or 317° C. In one form the hold temperature is at least 295° C. In another form the hold temperature is at least 300° C. In another form the hold temperature is at least 305° C. In another form the hold temperature is at least 310° C. In another form the hold temperature is at least 315° C. The hold temperature can be up to 400, 390, 380 or 370, 360, or 350° C.

The hold temperature can be in a range from above 290 to 400° C., preferably from 30 to 370° C., and in particular from 310 to 350° C.

The hold time is at least 0.5 hour, such as 1, 2, 3, 4 or 5 hours. In one form the hold time is at least two hours. In another form the hold time is at least three hours. In another form the hold time is at least three hours. In another form the hold time is at least four hours.

The hold time can be up to 20 hours, such as up to 15 hours, up to 10 hour or up to 8 hours. The hold time can be in a range from 1 to 20 hours, preferably from 2 to 15 hours, and in particular from 3 to 10 hours.

In one form the hold time is at least two hours at a hold temperature of at least 295° C. In another form the hold time is at least three hours at a hold temperature of at least 295° C. In another form the hold time is at least four hours at a hold temperature of at least 295° C.

In one form the hold time is at least two hours at a hold temperature of at least 300° C. In another form the hold time is at least three hours at a hold temperature of at least 300° C. In another form the hold time is at least four hours at a hold temperature of at least 300° C.

In one form the hold time is at least two hours at a hold temperature of at least 305° C. In another form the hold time is at least three hours at a hold temperature of at least 305° C. In another form the hold time is at least four hours at a hold temperature of at least 305° C.

In one form the hold time is at least two hours at a hold temperature of at least 310° C. In another form the hold time is at least three hours at a hold temperature of at least 310° C. In another form the hold time is at least four hours at a hold temperature of at least 310° C.

In one form the hold time is at least two hours at a hold temperature of at least 315° C. In another form the hold time is at least three hours at a hold temperature of at least 315° C. In another form the hold time is at least four hours at a hold temperature of at least 315° C.

The heating of the crude melamine polyphosphate is usually done while agitating the melamine phosphate, e.g. by stirring, or by injecting an inert gas. The inert gas may be air, nitrogen, or a noble gas, where nitrogen is preferred.

At the end of the hold time the resulting melamine depleted melamine polyphosphate can be cooled down, e.g. to below 150° C., 120° C. or 100° C. The cooling can be achieved by stirring without heating, or by injecting an inert gas which a lower temperature.

The melamine depleted melamine polyphosphate is usually obtained in solid form, e.g. as powder, and can be additionally grinded, milled, pressed, granulated or tableted.

During the heating of the crude melamine polyphosphate for a hold time residual water can evaporate. The residual water can be removed during the heating of the crude melamine polyphosphate, for example by purging with an inert gas or by applying a vacuum. During the hold time the crude melamine polyphosphate may be purged with an inert gas or subjected to a vacuum.

In one form the residual water is removed by purging with an inert gas. The inert gas may be air, nitrogen, or a noble gas, where nitrogen is preferred. The purging can be done by a volume stream which results in an exchange of the volume above the crude melamine polyphosphate at least 1, 2, 3, 4 or 5 times per hour.

In another form the residual water is removed by applying a vacuum, such as at least 0.9 bar, 0.5 bar or 0.1 bar.

The crude melamine polyphosphate is usually heated in an atmosphere to which no ammonia is added. In another form the crude melamine polyphosphate is heated in an atmosphere which is depleted of ammonia. In another form the crude melamine polyphosphate is heated in an inert gas atmosphere.

In one form the crude melamine polyphosphate can be free of a water-releasing compound, such as borax, aluminum hydroxide, magnesium hydroxide, and mixtures thereof. In another form the crude melamine polyphosphate may contain less than 5, 3, 2, 1, 0.5 or 0.1 wt % of the water-releasing compound.

In one form the crude melamine polyphosphate may be free of urea. In another form the reaction mixture may contain less than 5, 3, 2, 1, 0.5 or 0.1 wt % of urea. In another form the crude melamine polyphosphate may contain less than 0.1, 0.05, or 0.01 mol urea per mol of phosphoric acid.

In one form the crude melamine polyphosphate may be free of a metal oxide, metal hydroxide, metal oxohydroxide, metal (hydroxy)carbonates or layered double hydroxides (LDH) of Mg, Zn and Al, such as MgO, Mg(OH)2, Al₂O₃, Al(O)OH (Boehmit), ZnO, Zn(OH)2 und Mg, Al-, Zn, Al- and Mg/Zn, Al-hydrotalcit or hydromagnesit, MgCO3 or ZnCO3. In another form the crude melamine polyphosphate may contain less than 5, 3, 2, 1, 0.5 or 0.1 wt % of the metal oxide, metal hydroxide, metal oxohydroxide, metal (hydroxy)carbonates or layered double hydroxides (LDH) of Mg, Zn and Al.

In one form the crude melamine polyphosphate may be free of organic solvents. In another form the crude melamine polyphosphate may contain less than 5, 3, 2, 1, 0.5 or 0.1 wt % of an organic solvent.

The polyphosphate in the melamine depleted melamine polyphosphate may have a degree of polymerization of at least 10, 20, 30 or 40, and may be determined by 31P solid NMR.

The residual melamine concentration in the melamine depleted melamine polyphosphate is usually below 0.3 wt %, 0.25 wt %, 0.2 wt %, 0.15 wt %, 0.1 wt %, 0.08 wt %, 0.05 wt %, or 0.03 wt %. The residual melamine concentration can be determined by HPLC analysis on a strong cation-exchange phase with a Diode-Array Detection detector at 210 nm.

The melamine depleted melamine polyphosphate may contain 1 to 30, 5 to 25, or 10 to 20 wt % melam polyphosphate. In another form the melamine depleted melamine polyphosphate may contain up to 30, 25, 20, 15 or 10 wt % melam polyphosphate. In another form the melamine depleted melamine polyphosphate may contain at least 1, 5, 10, or 15 wt % melam polyphosphate. The concentration of the melam polyphosphate can be determined by HPLC on a cation-exchange type resin.

Melam is also known as N2-(4,6-diamino-1,3,5-triazin-2-yl)-1,3,5-triazine-2,4,6-triamine) and has the following chemical structure:

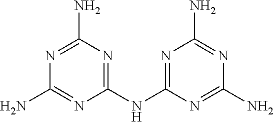 [SMILES: Nc1nc(N)nc(Nc2nc(N)nc(N)n2)n1]

The melamine depleted melamine polyphosphate may contain 0.01 to 5.0, 0.05 to 3.0 or 0.1 to 1.0 wt % melem polyphosphate. In another form the melamine depleted melamine polyphosphate may contain up to 15, 10, 5, 2 or 1 wt % melem polyphosphate. In another form the melamine depleted melamine polyphosphate may contain at least 0.01, 0.05, or 0.1 wt % melem polyphosphate. The concentration of the melem polyphosphate can be determined by HPLC on a cation-exchange type resin.

Melem is also known as 1,3,4,6,7,9,9b-Heptaazaphenalen-2,5,8-triamin and has the following chemical structure:

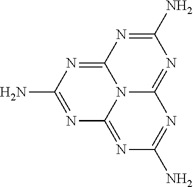 [SMILES: NC1=NC2=NC(N)=NC3=NC(N)=NC(=N1)N23]

In one form the hold time is at least two hours at a hold temperature of at least 300° C., and where during the hold time the crude melamine polyphosphate is purged with an inert gas or subjected to a vacuum.

In another form the hold time is at least two hours at a hold temperature of at least 310° C., and where during the hold time the crude melamine polyphosphate is purged with an inert gas or subjected to a vacuum.

In another form the hold time is at least two hours at a hold temperature of at least 320° C., and where during the hold time the crude melamine polyphosphate is purged with an inert gas or subjected to a vacuum.

In one form the hold time is at least two hours at a hold temperature of at least 300° C., and where during the hold time the crude melamine polyphosphate is purged with an inert gas or subjected to a vacuum, and where the crude melamine polyphosphate is produced by polymerizing a melamine phosphate for a polymerization time of at least 0.5 hour at a polymerization temperature in the range of 200 to 290° C.

In one form the hold time is at least two hours at a hold temperature of at least 310° C., and where during the hold time the crude melamine polyphosphate is purged with an inert gas or subjected to a vacuum, and where the crude melamine polyphosphate is produced by polymerizing a melamine phosphate for a polymerization time of at least 1 hour at a polymerization temperature in the range of 230 to 290° C.

In one form the hold time is at least two hours at a hold temperature of at least 320° C., and where during the hold time the crude melamine polyphosphate is purged with an inert gas or subjected to a vacuum, and where the crude melamine polyphosphate is produced by polymerizing a melamine phosphate for a polymerization time of at least 2 hours at a polymerization temperature in the range of 230 to 290° C.

In one form the hold time is at least two hours at a hold temperature of at least 300° C., and where during the hold time the crude melamine polyphosphate is purged with an inert gas or subjected to a vacuum, and where the crude melamine polyphosphate is produced by polymerizing a melamine phosphate for a polymerization time of at least 0.5 hour at a polymerization temperature in the range of 200 to 290° C., and where the melamine phosphate is prepared by adding phosphoric acid and water to a powder of melamine.

In one form the hold time is at least two hours at a hold temperature of at least 310° C., and where during the hold time the crude melamine polyphosphate is purged with an inert gas or subjected to a vacuum, and where the crude melamine polyphosphate is produced by polymerizing a melamine phosphate for a polymerization time of at least 1 hour at a polymerization temperature in the range of 230 to 290° C., and where the melamine phosphate is prepared by adding phosphoric acid and water to a powder of melamine.

In one form the hold time is at least two hours at a hold temperature of at least 320° C., and where during the hold time the crude melamine polyphosphate is purged with an inert gas or subjected to a vacuum, and where the crude melamine polyphosphate is produced by polymerizing a melamine phosphate for a polymerization time of at least 2 hours at a polymerization temperature in the range of 230 to 290° C., and where the melamine phosphate is prepared by adding phosphoric acid and water to a powder of melamine.

The invention also relates to a polymer composition (which is preferably a polyamide composition) comprising the melamine depleted melamine polyphosphate or comprising the melamine depleted melamine polyphosphate obtainable by the method for producing the melamine depleted melamine polyphosphate which comprises heating a crude melamine polyphosphate for a hold time of at least one hour to a hold temperature of at least 300° C.

The melamine polyphosphate can be used as flame retardant for polymers. Typical flame-retardant polymer compositions comprise 10 to 50 wt %, or 20 to 40 wt % of the melamine polyphosphate.

The flame-retardant polymer compositions may comprise:
35-55 wt % of a polymer
15-45 wt % of the melamine polyphosphate
0-50 wt % of a reinforcing fiber
0-20 wt % of a carbon-forming compound
0-10 wt % of a catalyst promoting carbon formation.

The flame-retardant polymer composition may comprise the following polymers:
1. Polymers of mono- and diolefins, for example polypropylene (PP), polyisobutylene, polybutylene-1, polymethylpentene-1, polyisoprene or polybutadiene; polyethylenes (optionally crosslinked) including, for example, high-density polyethylene (HDPE), low-density polyethylene (LDPE), linear low-density polyethylene (LLDPE), or mixtures of these polymers.
2. Copolymers of mono- and diolefins, optionally including other vinyl monomers such as, for example, ethylene-propylene copolymers, linear low-density polyethylene, and mixtures thereof with low-density polyethylene, as well as terpolymers of ethylene with propylene and a diene such as hexadiene, dicyclopentadiene or ethylidene norbornene; furthermore, mixtures of such copolymers with the polymers listed under 1 such as, for example, polypropylene/ethylene-propylene copolymers.
3. Polystyrene, poly-(p-methyl-styrene), poly-(a-methylstyrene) and copolymers of styrene or a-methylstyrene with dienes or acryl derivatives, such as, for example, styrene-butadiene, styrene-acrylonitrile, styrene-alkylmethacrylate, styrene-butadiene-alkylacrylate, styrene-maleic anhydride and styrene-acrylonitrile-methylacrylate.
4. Polyphenylene oxide and polyphenylene sulphide and their mixtures with styrene polymers or with polyamides.
5. Polyurethanes derived from polyethers, polyesters and polybutadiene with terminal hydroxy groups on the one hand and aliphatic or aromatic polyisocyanates on the other, as well as their precursors.
6. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 66/6, 6/66, polyamide 11, polyamide 12, aromatic polyamides based on an aromatic diamine and adipic acid; polyamides prepared from hexamethylene diamine and iso- and/or terephthalic acid and optionally an elastomer as modifier, for example poly-2,4, 4-trimethyl hexamethylene terephthalamide, poly-m-phenylene-isophthalamide.
7. Polyesters derived from dicarboxylic acids and dialcohols and/or from hydroxycarboxylic acids or the corresponding lactones such as polyethylene terephthalate, polybutylene terephthalate, poly-1,4-dimethylol cyclohexane terephthalate and polyhydroxybenzoates.
8. Thermosetting resins including, for example, unsaturated polyesters, saturated polyesters, alkyd resins, polyacrylate or polyether or compositions containing one or more of these polymers and a crosslinking agent.

The reinforcing fibers can be chosen from the group of inorganic reinforcing materials such as, for example, mica, clay or glass fibers; or aramide fibers and/or carbon fibers, or combinations thereof.

A number of substances are known to reinforce the flame-retardant action and may be included in the polymer composition as a carbon-forming compound. These substances include, for example, phenol resins, epoxy resins, melamine resins, alkyd resins, allyl resins, unsaturated polyester resins, silicon resins, urethane resins, acrylate resins, starch, glucose, and compounds with at least two hydroxy groups. Examples of compounds with at least two hydroxy groups include various alcohols such as pentaerythritol, dipentaerythritol, tripentaerythritol, and mixtures thereof. The concentration of such carbon-forming compounds in the polymer composition is typically less than 20 wt %, and preferably between 5 and 15 wt %.

A variety of catalyst promoting carbon formation may also be incorporated to promote carbon formation. These catalysts include, inter alia, metal salts of tungstic acid, complex acid oxides of tungsten with a metalloid, salts of tin oxide, ammonium sulphamate and/or its dimer. Metal salts of tungstic acid are preferably alkali metal salts, and in particular sodium tungstate. A complex acid oxides of tungsten with a metalloid are understood to be complex acid oxides formed from a metalloid such as silicon or phosphorus and tungsten. The amount of catalyst used in the polymer composition is generally 0.1-5 wt %, and preferably 0.1-2.5 wt %.

The flame-retardant action of the melamine polyphosphate can be further enhanced through the addition of a second flame retardant component. In principle any other known flame retardant may be used as the second flame retardant component. Examples include antimony oxides, for example antimony trioxide; alkali earth metal oxides, for example magnesium oxide; other metal oxides, for example alumina, silica, zinc oxide, iron oxide and manganese oxide; metal hydroxides, for example magnesium hydroxide and aluminium hydroxide; metal borates, for example hydrated or non-hydrated zinc borate; and phosphorus containing compounds.

Examples of phosphorus containing compounds are zinc phosphate, ammonium phosphate, ammonium pyrophosphate, ammonium polyphosphate, ethylene-diamine phosphate, piperazine phosphate, piperazine-pyrophosphate, melamine phosphate, dimelamine phosphate, melamine pyrophosphate, guanidine phosphate, dicyanodiamide phosphate and/or urea phosphate. Phosphonates and phosphate esters can also be used. Their content may vary within wide limits but generally does not exceed the content of the triazine derivative polyphosphate.

The polymer composition may further contain the other customary additives, for example stabilizers, release agents, flow agents, dispersants, colorants and/or pigments, in amounts that are generally applicable. The additive content of the polymer compositions is generally selected to ensure that the desired properties remain within acceptable limits, limits that will, of course, vary with the polymer composition and the intended application.

The polymer compositions can be prepared using most conventional techniques, including the dry mixing of all or a number of components in a tumble mixer, followed by melting in a melt mixer, for example a Brabender mixer, a single-screw extruder, or, preferably, a twin-screw extruder.

### EXAMPLES

### Example 1—Preparation of Melamine Phosphate

Melamine powder (6000 kg, 45.57 kmol, purity at least 99%) was heated to 70° C. Aqueous phosphoric acid (75 wt %, 4800 kg, 36.23 kmol) and water (1050 kg) were added under stirring at 80-100° C. to the melamine powder within seven hours. Water was removed during the process by applying a reduced pressure (about 300 mbar). The melamine phosphate was dried at about 105° C. in vacuum.

The yield was about 9550 kg of melamine phosphate powder, which contained melamine and phosphoric acid in a molar ratio of about 1.25 to 1.33. The melamine phosphate had a purity of >95% and a water content of below 1 wt % (determined with a moisture analyzer comprising a weighing and a halogen heating unit).

### Example 2—Polymerization of Melamine Phosphate

Melamine phosphate (9200 kg, from Example 1) was heated up from 20 to 290° C. in a stirred reactor. Although heating was continued the temperature of the melamine phosphate did not further increase above 290° C. This polymerization temperature was hold for a polymerization time of 2.5 hours. During the polymerization time an increase of pressure due to formation of reaction water was observed.

During the whole process the reactor was stirred and purged with nitrogen at an overpressure of about 30 mbar. Thus, the free gas volume in the reactor was exchanged about 5-7 times per hour.

The residual melamine concentration in the crude melamine polyphosphate was 0.3 wt % and was determined by as describe in Example 3.

At the end of the polymerization time the crude melamine polyphosphate was obtained and directly used in Example 3.

### Example 3—Heating the Crude Melamine Polyphosphate

The crude melamine polyphosphate produced in Example 2 was used directly without workup and at the polymerization temperature.

The temperature of the crude melamine polyphosphate was then increased from the polymerization temperature of 290° C. to the hold temperature. When a temperature of 300° C. and then 320° C. was reached then immediately samples were analyzed (Example A and Example B in Table 1).

The crude melamine polyphosphate was kept at the hold temperature for the hold time according to Table 1. During the hold time no increase of pressure due to formation of reaction water was observed.

Examples C was repeated twice starting from Example 1 and the results were listed as Example D and E.

During the hold time the reactor stirred and purged with nitrogen at an overpressure of about 30 mbar. Thus, the free gas volume in the reactor was exchanged about 5-7 times per hour.

At the end of the hold time the powder was cooled down while stirring to below 90° C. within 5 hours to yield about 7930 kg.

The melamine depleted melamine polyphosphate was obtained in Example C to F as white powder with acid number of up to 0.6 mg KOH/g (potentiometric titration with 0.1 M NaOH), a pH of about 5.5-6.5 (saturated solution at 20° C.).

The residual melamine concentration is given in wt % in Table 1 and was determined by HPLC on a Partisil® 10 SCX (strong cation-exchange phase based on benzenesulphonic acid, 25 cm length, particle size 10 μm) at 40° C. The mobile phase (0.7 ml/min) was water, buffer KH2PO4/H3PO4. Melamine was detected at around 5.4 min by a Diode-Array Detection DAD detector at 210 nm.

TABLE 1

| | | Residual Melamine |
|---|---|---|
| Example | Hold time and hold temperature | concentration |
| A | 0 hours at 300° C. | 0.3% |
| | (comparative example) | |
| B | 0 hours at 320° C. | 0.3% |
| | (comparative example) | |
| C | 5.5 hours at 320-330° C. | 0.006% |
| D | 5.5 hours at 320-330° C. | 0.013% |
| E | 5.5 hours at 320-330° C. | 0.005% |

The data in Table 1 showed that the residual melamine concentration can be reliably lowered to around 0.01% with the inventive process (Example C, D and E). For comparison, at lower temperature or shorter time the residual melamine concentration is higher.

1. A method for producing a melamine depleted melamine polyphosphate which comprises heating a crude melamine polyphosphate for a hold time of at least one hour to a hold temperature of above 290° C.

2. The method according to claim 1 where the crude melamine polyphosphate has a residual melamine concentration of at least 0.2 wt % melamine.

3. The method according to claim 1 where the melamine depleted melamine polyphosphate has a residual melamine concentration of below 0.2 wt %, 0.1 wt % or 0.05 wt %.

4. The method according to claim 1 where the hold temperature is at least 295, 300, 305, 310 or 315° C.

5. The method according to claim 1 where the hold time is at least 1, 2, 3, 4 or 5 hours.

6. The method according to claim 1 where during the hold time the crude melamine polyphosphate is purged with an inert gas or subjected to a vacuum.

7. The method according to claim 1 where the crude melamine polyphosphate is produced by polymerizing a melamine phosphate for a polymerization time of at least 0.5 hour at a polymerization temperature in the range of 200 to 290° C.

8. The method according to any of claim 7 where the melamine phosphate contains melamine and phosphoric acid in a molar ratio of 1:1 to 2:1, preferably of 1.2:1 to 1.5:1.

9. The method according to claim 7 where the melamine phosphate is prepared by heating melamine, phosphoric acid and water above 70° C.

10. The method according to claim 7 where the melamine phosphate is prepared by adding phosphoric acid and water to a powder of melamine.

11. The method according to claim 1 where the melamine depleted melamine polyphosphate contains 1 to 30 wt % melam polyphosphate.

12. A melamine depleted melamine polyphosphate which contains a residual melamine and where the residual melamine concentration is below 0.2 wt %, 0.1 wt % or 0.05 wt %.

13. The melamine depleted melamine polyphosphate according to claim 12 which contains 1 to 30 wt % melam polyphosphate.

14. The melamine depleted melamine polyphosphate according to claim 12 which contains 0.01 to 5.0 wt % melem polyphosphate.

15. The melamine depleted melamine polyphosphate according to claim 12, where the melamine depleted melamine polyphosphate is obtainable by the method as defined in claim 1 comprising heating the crude melamine polyphosphate for the hold time of at least one hour to the hold temperature of above 290° C.

16. A polymer composition comprising the melamine depleted melamine polyphosphate as defined in claim 13.
